(19) United States
(12) Patent Application Publication
(10) Pub. No.: US 2009/0128955 A1
(43) Pub. Date: May 21, 2009

(54) Data storage tape cartridge housing characterized by an absence of removable fasteners

(76) Inventors: Jason E. Moses, Breckenridge, MN (US); Nathan M. Gilsrud, Wahpeton, ND (US); Timothy R. Barr, Breckenridge, MN (US)

Correspondence Address: Imation Corp., P.O. Box 64898, St. Paul, MN, 55164-0898, US

(21) Appl. No.: 11/985,589

(22) Filed: Nov. 16, 2007

(51) Int. Cl. G11B 23/02

(52) U.S. Cl. 360/132

(57) ABSTRACT

A data storage tape cartridge includes first and second housing sections. The first housing section includes a plurality of posts while the second housing section includes a plurality of receptacles. The plurality of receptacles is configured to receive and couple to a respective one of the plurality of posts to provide a housing characterized by an absence of removable fasteners.

### TECHNICAL FIELD

This disclosure relates to a data storage tape cartridge. More particularly, it relates to joining housing sections of the data storage tape cartridge without removable fasteners.

### BACKGROUND

Data storage tape cartridges have been used for decades in the computer, audio, and video fields. The data storage tape cartridge continues to be a popular device for recording large volumes of information for subsequent retrieval and use.

A data storage tape cartridge generally includes an outer shell or housing maintaining at least one tape reel assembly and a length of magnetic storage tape. The storage tape is wrapped about a hub portion of the tape reel assembly and is driven through a defined path by a drive system. The housing normally includes two housing sections. Together, the housing sections form an opening (or window) at a forward portion thereof, permitting access to the storage tape by a read/write head upon insertion of the data storage tape cartridge into the tape drive.

Previously the data storage tape cartridge housing sections were joined by screws. Screws can be removed from the housing allowing for the housing pieces to be separated and the storage tape tampered with. Improved cartridge assembly, security, and tamper proofing are desired by both cartridge manufacturers and end-users.

### SUMMARY

One aspect provides a data storage tape cartridge. The data storage tape cartridge includes a tape reel assembly defining a reel gear, a brake assembly and a housing. The brake assembly is configured to move relative to the reel gear. The housing includes a first housing section and a second housing section configured to reciprocally mate with the first housing section to define an enclosure configured to maintain the tape reel assembly. The first housing section includes a first exterior surface and a first interior surface opposite the first exterior surface. A plurality of posts extends from the first interior surface. The second housing section includes a second exterior surface and a second interior surface opposite the second exterior surface. The second housing section defines a reel gear window configured to provide access to the reel gear of the tape reel assembly and a plurality of receptacles extending from the second interior surface. When the housing sections are assembled, each of the plurality of receptacles is configured to receive and couple to a respective one of the plurality of posts such that the housing is characterized by an absence of removable fasteners.

Another aspect relates to a method of assembling a housing of a data storage tape cartridge. The method includes providing a first housing section including a plurality of posts extending from a first interior surface of the first housing section and a second housing section including a plurality of receptacles that extend from a second interior surface of the second housing section. The method additionally includes inserting a respective one of the plurality of posts into a respective one of the plurality of receptacles to define a plurality of pillars within an enclosure of the housing. The method further includes bonding the first housing section to the second housing section.

Another aspect provides a data storage tape cartridge. The data storage tape cartridge includes at least one tape reel assembly disposed within a housing. The housing includes a first housing section and a second housing section configured to reciprocally mate with the first housing section to define an enclosure characterized by an absence of removable fasteners that is configured to maintain the tape reel assembly. The first housing section includes a first exterior surface and a first interior surface opposite the first exterior surface. A plurality of posts extends from the first interior surface. The second housing section includes a second exterior surface and a second interior surface opposite the second exterior surface. The second housing section defines a plurality of receptacles extending from the second interior surface. Means are provided for permanently bonding each of the plurality of posts with a respective one of the plurality of receptacles.

### BRIEF DESCRIPTION OF THE DRAWINGS

The accompanying drawings are included to provide a further understanding of embodiments and are incorporated in and constitute a part of this specification. The drawings illustrate embodiments and, together with the description, serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective, exploded view of a data storage tape cartridge according to one embodiment.

FIG. 2A is a top view of a second housing section of the data storage tape cartridge shown in FIG. 1.

FIG. 2B is a top view of a receptacle formed on an interior surface of the second housing section.

FIG. 3A is a bottom view of a first housing section of the data storage tape cartridge shown in FIG. 1.

FIG. 3B is a bottom view of a post formed on an interior surface of the first housing section.

FIG. 4A is a cross-sectional view of the first and second housing sections being joined.

FIG. 4B is an enlarged cross-sectional view of the post and the receptacle forming a pillar.

FIG. 5A is a perspective view of a post according to one embodiment.

FIG. 5B is a cross-sectional view of the post shown in FIG. 5A inserted into a receptacle.

FIG. 5C is a cross-sectional view of the post secured within the receptacle according to one embodiment.

FIG. 6 is a cross-sectional view of a post coupled to a receptacle in an alternative embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

Embodiments provide a cartridge housing having posts extending from a first housing section that are bonded to complimentary receptacles formed on an opposing second housing section. This bonding of the posts to the receptacles is characterized by an absence of removable fasteners and by the absence of bonding the perimeter edges of the cartridge housing sections. Removable fasteners include screws and other threaded fasteners. The bonding of the cartridge housings without removable fasteners provides a tamper-evident assembly that cannot be separated without obvious visual breaking or deformation of the housing. This bonding provides for more efficient housing assembly, improved cartridge security, and tamper-evident data storage tape cartridges. Bonding includes adhesive bonding, sonic welding, heat staking, solvent bonding and snap linking.

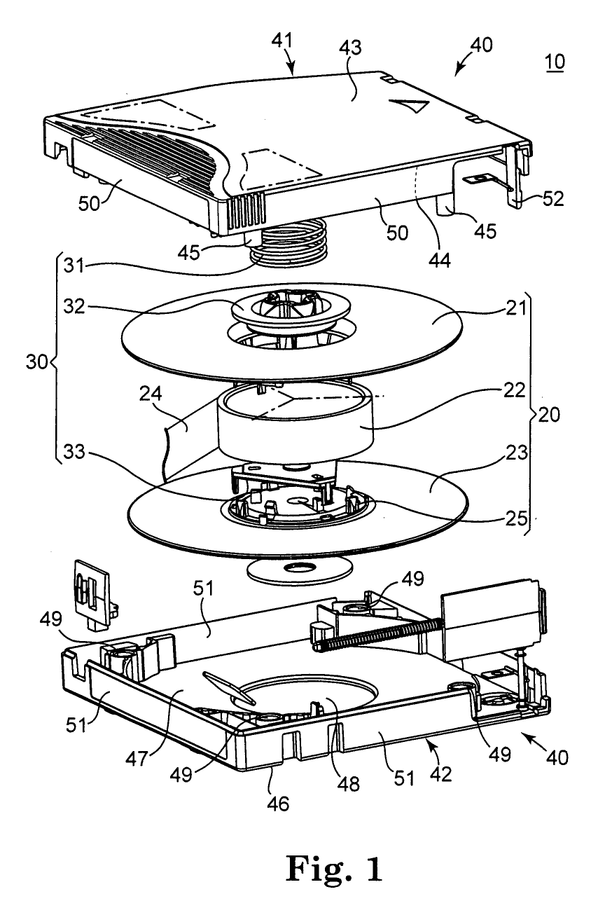

FIG. 1 is an exploded perspective view of a data storage tape cartridge 10 according to one embodiment. Generally, the cartridge 10 includes a tape reel assembly 20 maintaining a length of tape 24, a brake assembly 30 configured to selectively impede rotation of the tape reel assembly 20, and a housing 40.

The tape reel assembly 20 includes a tape reel 25, a cylindrical hub 22, an upper flange 21 and a lower flange 23. The tape reel 25 is connected to the lower flange 23. The cylindrical hub 22 is connected between the upper flange 21 and the lower flange 23. The magnetic tape 24 is wound around the hub 22 between the upper flange 21 and the lower flange 23. In one embodiment, the lower flange 23 of the tape reel assembly 20 engages the brake assembly 30. Although a single reel tape reel assembly 20 is illustrated, it is to be understood that embodiments provide a housing for dual reel and other tape reel assemblies, where the housing is characterized by an absence of removable fasteners.

The brake assembly 30 includes a flexible member 31 that interacts with a brake button 32 that engages the movable retainer member 33. When the movable retainer member 33 is forced away from the lower flange 23 of the tape reel assembly 20, the brake button 32 disengages from the tape reel assembly 20 and the flexible member 31 is compressed. This allows for the tape reel assembly 20 to freely rotate.

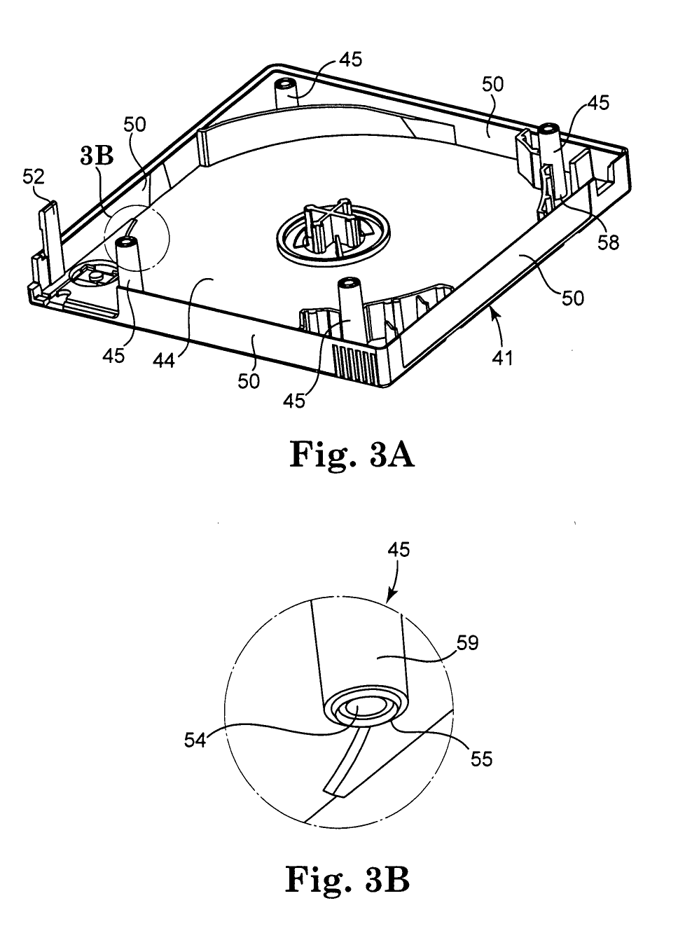

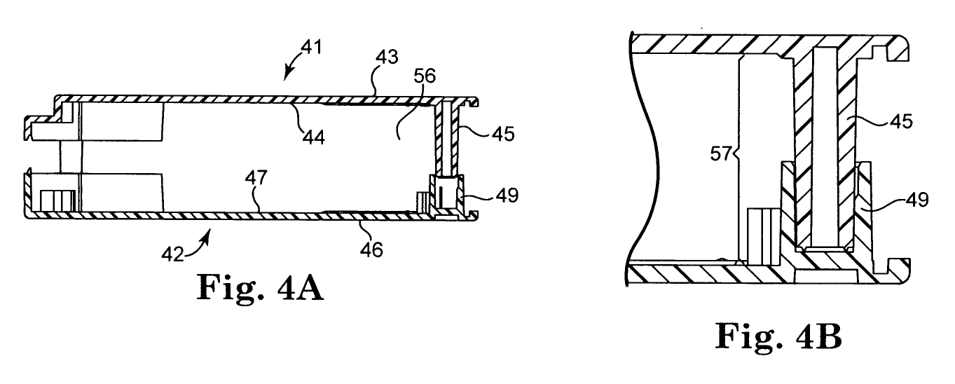

The housing 40 includes a first housing section 41 and a second housing section 42 that reciprocally mate to define an enclosure 56 (best illustrated in FIG. 4A). The first housing section 41 includes a first exterior surface 43 and a first interior surface 44 (best illustrated in FIG. 3A) opposite the first exterior surface 43. Extending from the first interior surface 44 is a plurality of posts 45 and a snap link 52.

The second housing section 42 includes a second exterior surface 46 (best illustrated in FIG. 4A), a second interior surface 47 opposite the second exterior surface 46, and defines a reel gear window 48 configured to provide access to the tape reel assembly 20. Extending from the second interior surface 47 of the second housing section 42 is a plurality of receptacles 49. When the housing 40 is assembled, each of the receptacles 49 receives one of the plurality of posts 45. The first housing section 41 defines side walls 50, and the second housing section 42 defines side walls 51 that combine to define a housing perimeter.

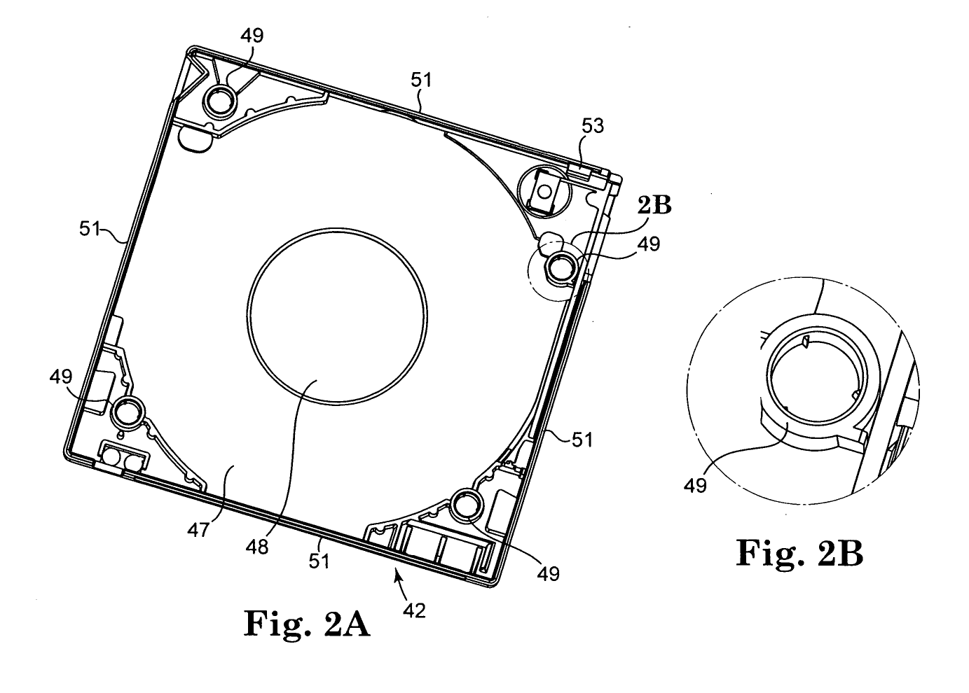

FIG. 2A is a top view of the second interior surface 47 of the second housing section 42. In one embodiment, the second housing section 42 defines four receptacles 49 integrally molded and located near the side walls 51 in differing corners. In other embodiments, the second housing section 42 defines more than four receptacles or fewer than four receptacles.

FIG. 2B is a top view of one of the receptacles 49 formed on the interior surface of the second housing section 42. The second housing section 42 defines a snap link window 53 that provides access for the snap link 52 found on the first housing section 41 (as illustrated in FIG. 1). In one embodiment, the snap link window 53 is integrally formed as part of the second housing section 42.

FIG. 3A is a bottom view of the first interior surface 44 of the first housing section 41 of the data storage tape cartridge shown in FIG. 1. The interior surface 44 is bounded by the side walls 50. Extending from the interior surface 44 is a plurality of posts 45 and a snap link 52. The snap link 52 is configured to interact with the snap link window 53 on the second housing section 42 (seen in FIG. 2A). In one embodiment, the posts 45 and snap link 52 are integrally formed as part of the first housing section 41.

FIG. 3B is an enlarged view of one of the posts 45. In one embodiment, the posts 45 include annular posts defining a base 58 coupled to the first interior surface 44, a tip 59 opposite the base 58, and an open end 54. The tip 59 comprises a bead of plastic 55 configured to melt and form a bond when melted to one of the receptacles 49.

Suitable materials for the housing 40, posts 45 and receptacles 49 include polycarbonate, ABS, ABS/PC blend, nylon, and acetal. Other plastics are also acceptable. Although four posts and four receptacles are shown, it is to be understood that other numbers of complimentary posts and receptacles are also acceptable. Some embodiments include more than four posts and four receptacles and other embodiments less than four posts and four receptacles.

FIG. 4A is a cross-sectional view of the first and second housing sections 41, 42 being joined. The first interior surface 44 opposes the second interior surface 47. One of the posts 45 slides into one of the receptacles 49. The posts 45 are characterized by an outer diameter that is smaller than an inner diameter of the receptacles 49. In another embodiment, the diameter of the posts 45 taper. This tapering of the posts 45 allows for a friction fit to occur between the posts 45 and the receptacles 49 when the housing sections 41 and 42 are press fitted.

FIG. 4B is an enlarged view one of the posts 45 inserted into one of the receptacles 49 to form a pillar 57. The perimeter of the housing 40 is characterized by the absence of a weld/connection. The housing 40 is tamper evident because of the housing sections 41, 42 must be broken/destroyed to be opened. In one embodiment, the plurality of posts 45 and the plurality of receptacles 49 are destructively bonded. Destructive bonding includes adhesive bonding, sonic welding, heat staking, solvent bonding, snap linking or melting an end portion of each pillar and then solidifying the melted end portion of each pillar. Destructively bonded means that the bonds cannot be undone without destroying the bonds and the housing.

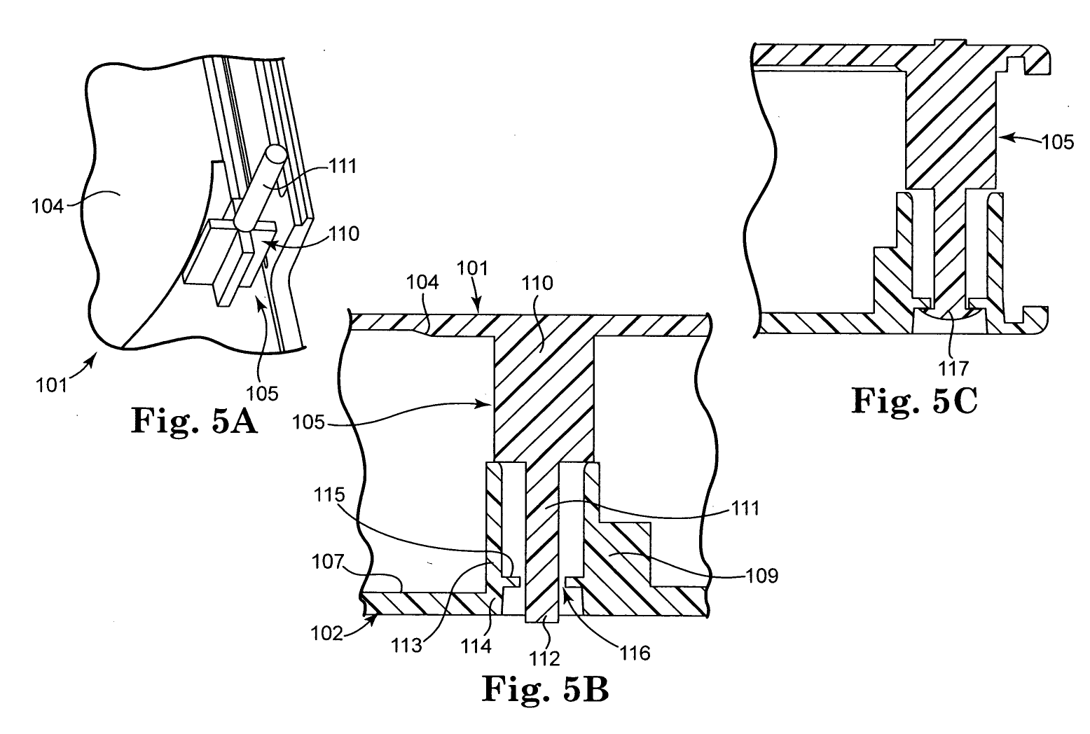

FIGS. 5A, 5B and 5C provide a process for bonding the housing sections 41 and 42 according to an alternative embodiment. The first housing section 101 defines a first interior surface 104 and a post 105 extending from interior surface 104. FIG. 5A is a perspective view of a post 105 according to one embodiment. The post 105 includes a boss 110 and a pole 111 connected to the boss 110. FIG. 5B is a cross-sectional view of the post 105 shown in FIG. 5A inserted into the receptacle 109. The post 105 defines a boss 110 and a pole 111 extending from boss 110. The pole 111 defines an end tip 112. The second housing section 102 defines a second interior surface 107 and receptacle 109. In one embodiment; the receptacle 109 provides a through-hole, a first section 113 and a second section 114. The two sections 113, 114 of the receptacle 109 are divided by an annular shoulder 115 that extends toward the center of the receptacle. The annular shoulder 115 defines a hole 116. When the pole 111 is inserted into the hole 116, the boss 110 abuts against the first section 113 of the receptacle 109 while the pole 111 passes through the receptacle and through the hole 116 created by the annular shoulder 115. FIG. 5C is a cross-sectional view of the post secured within the receptacle according to one embodiment. In FIG. 5C, the pole 111 is heated, formed or otherwise deformed to create an end portion 117. The end portion 117 is defined by a diameter greater than the hole 116 created by the annular shoulder 115. This joins the first housing section 101 to the second housing section 102.

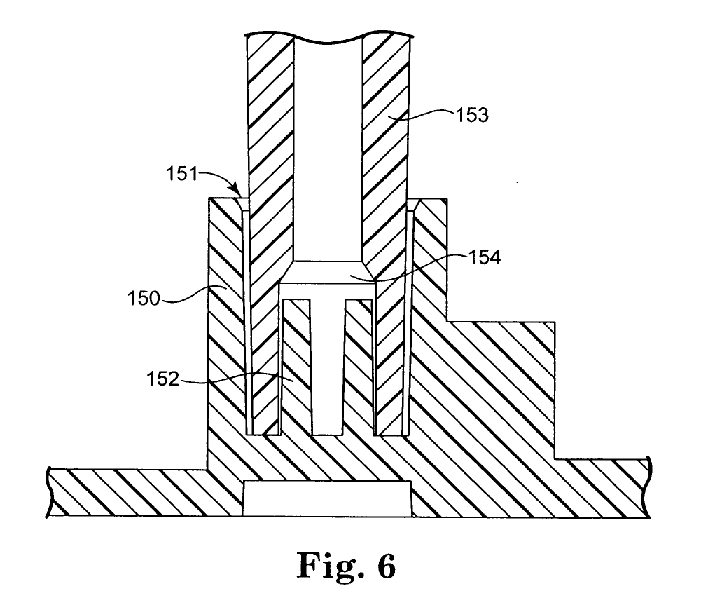

FIG. 6 is a cross-sectional view of a post 153 coupled to a receptacle 150 in an alternative embodiment. The receptacle 150 defines a well 151. A boss 152 is centered inside the well 151 of the receptacle 150. The post 153 defines a hollow interior 154. The hollow interior 154 is defined by a diameter that is larger than the diameter of the boss 152. In this manner the post 153 fits inside the well 151 of the receptacle 150 and around the boss 152. Embodiments provide a data storage tape cartridge including housing sections that are assembled without removable fasteners.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of data storage tape cartridge housings that are assembled without removable fasteners. Therefore, it is intended that this invention be limited only by the claims and the equivalents thereof.

What is claimed is:

1. A data storage tape cartridge comprising:
a tape reel assembly;
a brake assembly configured to selectively restrict movement of the tape reel assembly; and
a housing including a first housing section and a second housing section configured to reciprocally mate with the first housing section to define an enclosure configured to maintain the tape reel assembly, the first housing section including a first exterior surface and a first interior surface opposite the first exterior surface and a plurality of posts extending from the first interior surface, the second housing section including a second exterior surface and a second interior surface opposite the second exterior surface and defining a reel gear window configured to provide access to a reel gear of the tape reel assembly, and a plurality of receptacles extending from the second interior surface;
wherein when assembled each of the plurality of receptacles is configured to receive and couple to a respective one of the plurality of posts and the housing is characterized by an absence of removable fasteners.

2. The data storage tape cartridge of claim 1, wherein each of the first housing section and the second housing section defines side walls that combine to define a housing perimeter when the housing is assembled.

3. The data storage tape cartridge of claim 2, wherein the side walls are not sealed together along the housing perimeter.

4. The data storage tape cartridge of claim 2, wherein one side wall of the first housing section includes a snap link extending from the first interior surface and one side wall of the second housing section defines a window configured to receive an end of the snap link.

5. The data storage tape cartridge of claim 1, wherein each of the plurality of posts defines an annular post defining an open end.

6. The data storage tape cartridge of claim 5, wherein each of the annular posts defines an outside diameter that is smaller than an inside diameter of each of the plurality of receptacles such that each annular post slides into a respective receptacle.

7. The data storage tape cartridge of claim 5, wherein each of the plurality of posts defines a base coupled to the first interior surface and a tip opposite the base, the tip comprising an annular bead of plastic.

8. A method of assembling a housing of a data storage tape cartridge, the method comprising:
providing a first housing section comprising a plurality of posts extending from a first interior surface of the first housing section and a second housing section comprising a plurality of receptacles extending from a second interior surface of the second housing section;
inserting a respective one of the plurality of posts into a respective one of the plurality of receptacles to define a plurality of pillars within an enclosure of the housing; and
bonding the first housing section to the second housing section.

9. The method of claim 8, wherein bonding the first housing section to the second housing section comprises deforming an end of the post.

10. The method of claim 9, wherein deforming the end of the post includes changing a diameter of the end of the post.

11. The method of claim 8, wherein bonding the first housing section to the second housing section comprises:
melting an end portion of each pillar; and solidifying the melted end portion of each pillar.

12. The method of claim 9, further comprising:
snapping a snap link defined by the first housing section into a snap window defined by the second housing section.

13. The method of claim 9, wherein bonding the first housing section to the second housing section comprises adhesively bonding a respective one of the plurality of posts with a respective one of the plurality of receptacles.

14. A data storage tape cartridge comprising:
at least one tape reel assembly;
a housing including a first housing section and a second housing section configured to reciprocally mate with the first housing section to define an enclosure characterized by an absence of removable fasteners that is configured to maintain the at least one tape reel assembly, the first housing section including a first exterior surface and a first interior surface opposite the first exterior surface and a plurality of posts extending from the first interior surface, the second housing section including a second exterior surface and a second interior surface opposite the second exterior surface, and a plurality of receptacles extending from the second interior surface; and
means for permanently bonding each of the plurality of posts with a respective one of the plurality of receptacles.

15. The data storage tape cartridge of claim 14, wherein the means for permanently bonding the first housing section to the second housing section comprises sonic welding of the plurality of posts to the second housing section within the plurality of receptacles.

16. The data storage tape cartridge of claim 14, wherein the means for permanently bonding the first housing section to the second housing section comprises heat staking the plurality of posts to the plurality of receptacles.

17. The data storage tape cartridge of claim 14, wherein the means for permanently bonding the first housing section to the second housing section comprises snap linking.

18. The data storage tape cartridge of claim 14, wherein the means for permanently bonding the first housing section to the second housing section comprises forming a destructive bond between the first and second housing sections.

19. The data storage tape cartridge of claim 14, wherein the at least one tape reel assembly comprises a single reel tape assembly including a reel gear, and the second housing section defines a reel gear window configured to provide access through the housing to the reel gear.
